(19) United States
(12) Patent Application Publication
(10) Pub. No.: US 2021/0140637 A1
(43) Pub. Date: May 13, 2021

(54) SANITIZING BREATH ADAPTER FOR BLOWING OUT CANDLES

(71) Applicant: Andy Roman Dubon, Los Angeles, CA (US)

(72) Inventor: Andy Roman Dubon, Los Angeles, CA (US)

(21) Appl. No.: 16/676,968

(22) Filed: Nov. 7, 2019

(51) Int. Cl. F23Q 25/00; B01D 46/24

(52) U.S. Cl. CPC F23Q 25/00; B01D 2279/65; B01D 46/2403

(57) ABSTRACT

A breath adapter device is provided in embodiments where an individual uses his/her breath for a specific purpose, such as extinguishing birthday candles. The breath adapter device includes an elongated hollow tube forming a mouthpiece enabled to accept air from a user's breath, a tubular breath outflow at an end of the tube opposite the mouthpiece. A filter may be included and positioned at the hollow tube between the mouthpiece and the outflow and air is forced through the filter container, which captures spittle, bacteria and other contaminates before exiting the outflow.

### BACKGROUND OF THE INVENTION

### 1. Field of the Invention

The present invention is in the field of modular breath adapters and pertains particularly to methods and apparatus for filtering breath before blowing out candles on a cake or other food presentation.

### 2. Discussion of the State of the Art

Traditional birthday celebrations for many include cake and candles. Candles may number the same number of years being celebrated. The person having the birthday typically blows onto lit candles on the cake to make his or her birthday wish come true. One problem with the tradition is that often people who will blow out the candles may be sick with cold or virus that may transfer onto a cake through the person's breath. Also, spittle, saliva, mucous, or other contaminants may be propelled onto a cake by a person attempting to blow out candles.

The inventor is aware of a birthday candle breath adapter in the form of a cone having a narrow end for a person's mouth and having an opposite wider end of significantly larger diameter through which the person's breath flows out and onto candles. The breath adapter known to the inventor contains a thin screen, termed a filter, for screening out spittle and particles. The filter in the device known to the inventor is inadequate for filtering finer particles beyond 20 or so microns in diameter.

Therefore, what is clearly needed is a filter section that includes a filter for at least finer particulates and a breath diffusion baffle upstream from the filter section.

### SUMMARY

In one embodiment of the present invention a breath adapter is provided comprising an elongated hollow tube forming a mouthpiece having a shape, length and a diameter enabled to accept air from a user's breath. A tubular breath outflow is provided in this embodiment having a second length and second diameter at an end of the tube opposite the mouthpiece. A filter may be provided having a third diameter and a third length positioned at the hollow tube between the mouthpiece and the outflow, wherein air is forced through the filter container, which captures spittle, bacteria and other contaminates before exiting the outflow.

In another embodiment a diffusion cap may be provided and is positioned at the outflow and air flow travelling through the filter container and exiting the outflow is of a force enabling at least flame extinguishing on birthday candles.

In a main embodiment, the filter container has a diameter less than the mouthpiece and outflow and is enabled to push into and secure the mouthpiece and the diffusion cap in a linear position. Additionally, the mouthpiece includes concave indentations enabling fingers to grip the breath adapter. In this embodiment, the concave indentations are enabled to removably attach an ornamental ring enabled to be worn on a finger of a user. In another embodiment, the mouthpiece includes a diffusion cap including a plurality of uniform openings to uniformly direct the breath flow from the user through the device to the filter in the filter section.

### BRIEF DESCRIPTION OF THE SEVERAL VIEWS OF THE DRAWINGS

FIG. 1 is a perspective view of an assembled breath adapter according to an embodiment of the present invention.

FIG. 2A is a side elevation view of the assembled breath adapter of FIG. 1 including a birthday ring resting in a snap groove.

FIG. 2B is a front end view of the assembly of FIG. 2A.

### DETAILED DESCRIPTION OF THE INVENTION

In various embodiments described in enabling detail herein, the inventor provides a unique system for filtering a person's breath while the person is attempting to blow out candles on a cake. The present invention is described using the following examples which may describe more than one relevant embodiment falling within the scope of the invention.

FIG. 1 is a perspective view of an assembled breath adapter 100 according to an embodiment of the present invention. Breath adapter 100 is adapted to enable a person to filter his or her own breath while blowing out candles such as candles placed on a birthday cake. Breath adapter 100 is assembled from substantially straight tubing sections including a body and mouthpiece 101, a filter container 103, and a breath outflow 104.

In this embodiment, primary body and mouthpiece 101 may be manufactured from medical grade polymer tubing, from durable medical grade steel, or other appropriate material, such as glass without departing from the spirit and scope of the invention. Body and mouthpiece 101 is a round tube or cylinder having an outside diameter and an inner diameter. The mouth piece may be oval, elliptical, rectangular, or tapered, as well.

Body and mouthpiece 101 includes ergonomic divots 102a (not shown) and 102b, opposite 102a, machined or otherwise formed into the wall of body and mouthpiece 101. Divots 102a and 102b are adapted to function as ergonomic positionally-opposed finger rests allowing a person to comfortably hold breath adapter 100 while in use. Divots 102a and 102b may be designed differently, for example not in exact opposite position, to accommodate for a comfortable position of one or more fingers on one side and a thumb on the opposite side or may have no indentations.

Filter section 103 is a straight tubing section having an outside diameter and an inside diameter. Filter section 103 may be manufactured from medical grade polymer tubing, from medical grade stainless steel tubing, glass or other appropriate material without departing from the spirit and scope of the present invention. Filter section 103 is adapted to contain or secure a material filter (not illustrated) therein and to hold the filter material, filter plug, filtering device, or filter apparatus between the body mouthpiece 101 and the breath 104.

Filter section 103 has an outside diameter just smaller than an inside diameter provided at the interfacing end of body mouthpiece 101. In one embodiment, filter section 103 is press fit into a counter-bore of sufficient depth to accept and securely hold the filter section. In another embodiment, the outside wall of filter section 103 interfacing with body mouthpiece 101 is threaded with male threads to a sufficient depth to be threaded into female threads provided on the inner diameter as defined by said counter bore at a sufficient depth such that the parts may be screwed together to a stop (bottom of counter-bore). In still another embodiment, the outside diameter of filter section 103 is just smaller than the inside diameter of the mentioned counter-bore and wherein additional features are provided to create a press in and twist-lock connection. The features may include a slot running orthogonal to the direction of longitudinal center of the filter section wall at the end interfacing with body mouthpiece 101, and a mating aperture formed at the bottom of said counter-bore. In this embodiment the pieces are held together by the twist and lock feature. In an alternative embodiment the inner and outer dimensions of the pieces enable a secure push on and pull off feature which may include an O-ring of pliant material to create an airtight seal.

Air outflow 104 is a round tubing section having an outer diameter and an inner diameter, outflow 104 may be manufactured from ft medical grade polymer, from ft medical grade steel, or other appropriate material without departing from the spirit and scope of the present invention. By tapering the outflow and having the outflow 104 narrowed it may help keep the air pressure at a maximum to help blow out the candles. Outflow 104 may include a second counter-bore placed at the interfacing end thereof to a significant depth that will accept the outside diameter of free end of filter section 103 after it is assembled to body mouthpiece 101. Filter section 103 may be assembled in any of the three ways described above with reference to the end that attaches to body mouthpiece 101, more particularly, press fit, twist and lock, snap fit, or a threaded connection.

Filter section 103 may house a material filter that is porous enough to allow free air flow but restricted in pore diameter enough to prevent fluids and fine particulate matter from exiting the filter section. In one embodiment, the filter contained in filter section 103 may be a filter plug designed to take up much of the volume within section 103. In one embodiment, filter section 103 may house a plurality of disc-like individual filters or screen filters in a filter stack (two or more filter screens or discs). In another embodiment, filter section 103 may house a filter material that is pliable and can be inserted within the filter section manually. In one embodiment, the filter or filter material used may be treated with an antiseptic or other germ killing solution.

FIG. 2A is a side elevation view of the assembled breath adapter 100 of FIG. 1 including a birthday ring resting in a snap groove. In this view, body mouthpiece 101 is depicted in elevation so that divots 102a and 102b are visible. In one embodiment, the mouthpiece end of body mouthpiece 101 is completely open and breath is not treated until it is in the filter section.

In this embodiment, a breath diffusion cap 204 is provided having at least a few openings or pathways 203 placed through it to allow breath to pass through the device. Diffusion cap 204 functions like a baffle to uniformly direct the gas flow (breath) from the user through the device to the filter in the filter section. There may be more than four or fewer than four gas flow openings 203 in diffusion cap 204 without departing from the spirit and scope of the present invention. Cap 204 may be a cap having a small concentric interfacing rim provided on one side having an outside diameter just smaller that the inside diameter of body mouthpiece 101 at the mouthpiece end. The directional arrow depicts the direction of forced breath through device 100.

It is noted herein that the stock inside diameter of mouthpiece 101 is flared out to a larger inside diameter at the end that a person's mouth connects to the mouthpiece 101 so that cap 204 may be pressed or snapped in. There may be more than one interchangeable diffusion caps provided with differing numbers and or sizes of openings provided for gas/air/breath flow. Cap 204 may be pressed into or onto the mouthpiece opening without departing from the spirit and scope of the present invention. In one embodiment, body mouthpiece 101 is completely open at the both ends and one or more diffusion caps 204 are provided to snap onto either end or both ends of the filter section 103 wherein the breath flow is diffused both before and after being filtered in filter section 103.

Filter section 103 bottoms out and forms an airtight seal when threaded into body mouthpiece 101 due to the smaller inside diameter of the tube at the bottom of the counter bore seating the filter tube section. Filter section 103 also bottoms out forming an airtight seal when threaded or otherwise installed into outflow 104 due to the smaller inside diameter of the outflow 104 tubing section at the bottom of the counter bore. This enables the filter section 103 to be open at both ends, provide an airtight passage for breath to pass through breath adapter 100, and to prevent filter section 103 from dislodging from either mouthpiece 101 or outflow 104 during use

Ring 201 may serve as a stabilizing ring to hold onto in use. Additionally, ring 201 may be decorative and serve as a finger adornment ring to be worn by the individual having a birthday. Ring 201 is seated in this embodiment into a radial groove provided at bottom center of divot 102a in this example. Ring 201 may be pressed down to snap into the groove and be pulled off of the groove manually. In one embodiment grooves for holding birthday ring 201 may be placed in either or both finger divots 102a and 102b allowing for a ring 201 to be attached to either side or both sides of mouthpiece 101.

FIG. 2B is a front, end view of the assembly of FIG. 2A. Ring 201 is placed into a groove at center of the top finger divot 102a. The groove is radial and stops in depth just short of the smaller inner diameter of body mouthpiece 101 so it does not break through the wall. The groove may be machined as a snap groove having walls that angle or arc inward to an extent that the groove expands and grips the ring 201 when it is urged downward onto the groove. In this example, cap 204 includes four openings 203 to allow breath to enter the device. In other embodiments, the number and placement of openings 203 through cap 204 may vary. In one embodiment, the mouthpiece 101 is open and the diffusion cap 204 is provided on one end or both ends of filter section 103.

In general assembly of device 100, a user may or may not install diffusion cap 204 onto the mouthpiece end of body 101. The user may then install one cap 204 to either or both ends of filter section 103. The user may then place a filter material, a filter plug, or a filter device, into filter section 103. The user may then install end cap 204 onto the outflow or inflow end of filter section 103 completing the assembly of device 100. A user may optionally install cap 204 into a snap groove provided for the purpose.

It will be apparent to the skilled person that the arrangement of elements and functionality for the invention is described in different embodiments in which each is exemplary of an implementation of the invention. These exemplary descriptions do not preclude other implementations and use cases not described in detail. The invention is limited only by the breadth of the claims below.

1. A breath adapter device, comprising;
an elongated hollow tube forming a mouthpiece having a shape, length and a diameter enabled to accept air from a user's breath;
a tubular breath outflow having a second length and second diameter at an end of the tube opposite the mouthpiece; and
a filter having a third diameter and a third length positioned at the hollow tube between the mouthpiece and the outflow;
wherein air is forced through the filter container, which captures spittle, bacteria and other contaminates before exiting the outflow.

2. The breath adapter of claim 1, wherein a diffusion cap is positioned at the outflow and air flow travelling through the filter container and exiting the outflow is of a force enabling at least flame extinguishing on birthday candles.

3. The breath adapter of claim 1, wherein the filter container has a diameter less than the mouthpiece and outflow and is enabled to push into and secure the mouthpiece and the diffusion cap in a linear position.

4. The breath adapter of claim 1, wherein the mouthpiece includes concave indentations enabling fingers to grip the breath adapter.

5. The breath adapter of claim 5, wherein the concave indentations are enabled to removably attach an ornamental ring enabled to be worn on a finger of a user.

6. The breath adapter of claim 1, wherein the mouthpiece includes a diffusion cap including a plurality of uniform openings to uniformly direct the breath flow from the user through the device to the filter in the filter section.
